(19) United States
(12) Patent Application Publication
(10) Pub. No.: US 2015/0363156 A1
(43) Pub. Date: Dec. 17, 2015

(54) MEDIA SPLITTING AND REDUCTION IN STORAGE REQUIREMENTS BASED ON COMMON CONTENT

(71) Applicant: International Business Machines Corporation, Armonk, NY (US)

(72) Inventors: Gary D. Cudak, Creedmoor, NC (US); Lydia M. Do, Raleigh, NC (US); Christopher J. Hardee, Raleigh, NC (US); Adam Roberts, Moncure, NC (US)

(21) Appl. No.: 14/304,099

(22) Filed: Jun. 13, 2014

(51) Int. Cl. G06F 3/16

(52) U.S. Cl. CPC G06F 3/165

(57) ABSTRACT

A method and computer program product for executing the method, where the method includes analyzing a multimedia file including audio content and video content, identifying a portion of the audio content that matches a portion of a separate audio file, removing the identified portion of the audio content from the multimedia file, and inserting a link into the multimedia file. The link points to the known audio file, specifies the portion of the separate audio file that matches the removed portion of the audio content, and identifies a point in the multimedia file where the portion of audio content was removed. During playback of the multimedia file, the specified portion of the known audio file is played at the identified point in the multimedia file.

### BACKGROUND

1. Field of the Invention

The present invention relates to systems and methods for storing and reproducing multimedia content.

2. Background of the Related Art

Multimedia file servers have become a very popular way to share and view multimedia files. Individual users can capture or produce a multimedia file, including both audio and video, and upload them to a multimedia file server. Those same multimedia files may then be requested and viewed by users all over the globe. The relative ease of creating a multimedia file and the prevalent use of devices that can capture and upload multimedia has caused the number and size of multimedia files to grow rapidly.

Multimedia files can consume a large amount of data storage capacity. For example, a typical music audio file, such as an MP3 file, may require between 3 and 5 or more megabytes.

### BRIEF SUMMARY

One embodiment of the present invention provides a method comprising analyzing a multimedia file including audio content and video content, identifying a portion of the audio content that matches a portion of a separate audio file, removing the identified portion of the audio content from the multimedia file, and inserting a link into the multimedia file. The link points to the known audio file, specifies the portion of the separate audio file that matches the removed portion of the audio content, and identifies a point in the multimedia file where the portion of audio content was removed. During playback of the multimedia file, the specified portion of the known audio file is played at the identified point in the multimedia file.

Another embodiment of the present invention provides a computer program product comprising a computer readable storage medium having program instructions embodied therewith, where the program instructions are executable by a processor to cause the processor to perform a method. The method comprises analyzing a multimedia file including audio content and video content, identifying a portion of the audio content that matches a portion of a separate audio file, removing the identified portion of the audio content from the multimedia file, and inserting a link into the multimedia file. The link points to the known audio file, specifies the portion of the separate audio file that matches the removed portion of the audio content, and identifies a point in the multimedia file where the portion of audio content was removed. During playback of the multimedia file, the specified portion of the known audio file is played at the identified point in the multimedia file.

### BRIEF DESCRIPTION OF THE SEVERAL VIEWS OF THE DRAWINGS

FIG. 1 is a diagram of a system including a communication network enabling communication between a plurality of communication devices, including a mobile communication device.

FIG. 2 is a diagram of a mobile communications device capable of uploading and downloading multimedia files.

FIG. 3 is a diagram of a computer that may implement a multimedia file server in accordance with one embodiment of the present invention.

FIG. 4 is a diagram illustrating various aspects of a method in accordance with one embodiment of the present invention.

FIG. 5 is a flowchart of a method in accordance with one embodiment of the present invention.

### DETAILED DESCRIPTION

One embodiment of the present invention provides a method comprising analyzing a multimedia file including audio content and video content, identifying a portion of the audio content that matches a portion of a separate audio file, removing the identified portion of the audio content from the multimedia file, and inserting a link into the multimedia file. The link points to the known audio file, specifies the portion of the separate audio file that matches the removed portion of the audio content, and identifies a point in the multimedia file where the portion of audio content was removed. During playback of the multimedia file, the specified portion of the known audio file is played at the identified point in the multimedia file.

The method may, for example, be performed by a multimedia web server where a large number of user upload multimedia files for sharing and viewing by other users. The method may be used to deduplicate audio storage and reduce overall storage requirements for multimedia files by replacing certain audio portions with a link to the same or similar audio when multimedia file is requested. Accordingly, the multimedia file is stored with the link and without the identified portion of the audio content. The analysis of audio content, identification of matching portions of separate audio files, and the creation of the links, as described herein, may be performed either inline as the multimedia files are uploaded to a multimedia server or offline after the multimedia file has already been uploaded and stored.

The portion of the audio content that matches a portion of a separate audio file may be identified by comparing the audio content of the multimedia file with a database of audio files. While the multimedia file may include other audio that is original, unrecognizable, too small to identify or too small to present an opportunity for significant savings in file storage, the identified portion of the audio content may also be found to be entirely within one or more separate audio files of a database. For example, where one or more popular songs has been used as a sound track for a video, the songs may be removed and replaced with a link to the same songs in a database. Optionally, the database version of the song may even be of a higher or lower quality audio than the identified portion of the audio content from the multimedia file.

As stated above, the link points to the known audio file, specifies the portion of the separate audio file that matches the removed portion of the audio content, and identifies a point in the multimedia file. The point in the multimedia file where the portion of audio content was removed may be identified by a start time and an end time. The timeline for the multimedia file is unchanged. The start time indicates how far into the timeline the portion of the separate audio file should begin. The end time indicates where in the timeline the portion of the separate audio file should be completed.

In one embodiment, a multimedia player is used to play back the multimedia file that has been stored with the link rather than the audio content. During playback, the multimedia file stored with the link may be provided to the multimedia player in a first data stream and the specified portion of the separate audio file may be provided to the multimedia player in a second data stream. Optionally, the specified portion of the separate audio file may be obtained or buffered prior to the start time where the audio content needs to be inserted.

Optionally, the method may analyze the portion of the audio content to identify an audio effect applied to the portion of the audio content relative to the specified portion of the audio file. Any identifiable audio effect may be specified and stored as part of the link or some other part of the multimedia file, such as metadata. If the multimedia player has the capability of applying audio effects, then the multimedia player may apply the specified audio effect during playback. Alternatively, the multimedia server may add the specified audio effect prior to streaming the portion of the audio file to the multimedia player.

The method may also balance the desire to reduce the data storage requirements of the multimedia files with the workload of analyzing the audio content and linking to separate audio files. Accordingly, the method may determine an amount of data included in the identified portion of the audio content, wherein the identified portion of the audio content is removed and the link inserted only in response to the amount of data exceeding a setpoint amount. In other words, really small portions of audio content that might be the same as part of a separate audio file are not worth the workload required. The link will only replace the audio content, if the identified portion of audio content exceeds the setpoint amount.

Since multimedia files are more likely to include popular songs than lesser known songs, the method may limit the analysis to highly popular songs. The scope of the database of audio files used in the analysis may also limit the workload of performing the method, while achieving the greatest data storage benefits.

In addition, the method may be applied to the video content of a multimedia file. Accordingly, if a portion of the video content is identified as being the same as a portion of a separate video file in a database, then that identified portion of the video content may be replaced with a link pointing to the separate video file, specifying the portion of the separate video file that matches the removed portion of the video content, and identifies a point in the multimedia file wherein the specified portion of the separate video file is to be reinserted. This deduplication of video content may be most useful with highly popular clips perhaps selected because there are trending or receiving a high number of views.

Another embodiment of the present invention provides a computer program product comprising a computer readable storage medium having program instructions embodied therewith, where the program instructions are executable by a processor to cause the processor to perform a method. The method comprises analyzing a multimedia file including audio content and video content, identifying a portion of the audio content that matches a portion of a separate audio file, removing the identified portion of the audio content from the multimedia file, and inserting a link into the multimedia file. The link points to the known audio file, specifies the portion of the separate audio file that matches the removed portion of the audio content, and identifies a point in the multimedia file where the portion of audio content was removed. During playback of the multimedia file, the specified portion of the known audio file is played at the identified point in the multimedia file.

The foregoing computer program product may further include program instructions for implementing or initiating any one or more aspects of the methods described herein. Accordingly, a separate description of the methods will not be duplicated in the context of a computer program product.

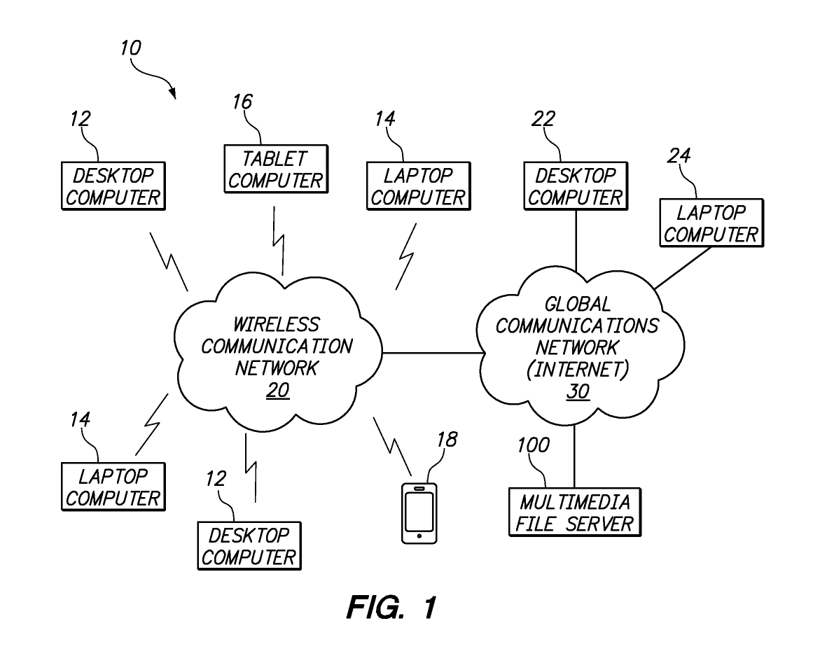

FIG. 1 is a diagram of a system 10 including a wireless communication network 20 communicating with a plurality of communication devices, such as desktop computers 12, laptop computers 14, tablet computer 16, and a mobile communication device or smartphone 18. The wireless communication network 20 may also communicate with a global communications network 30, such as the Internet. Furthermore, the desktop computer 22 and the laptop computer 24 may communicate directly with the global communications network 30 without going through the wireless communication network 20. A multimedia file server 100 is coupled to the global communications network 30 and hosts online games. Optionally, the multimedia file server 100 may provide accounts to users (players) of the various devices 12, 14, 16, 18, 22, 24 and allow the players to access and play the online games. The multimedia file server 100 may monitor and store records regarding each player's activities while logged on, such as each player's preferred games, preferred areas within the games, player sentiment and duration of time in-game.

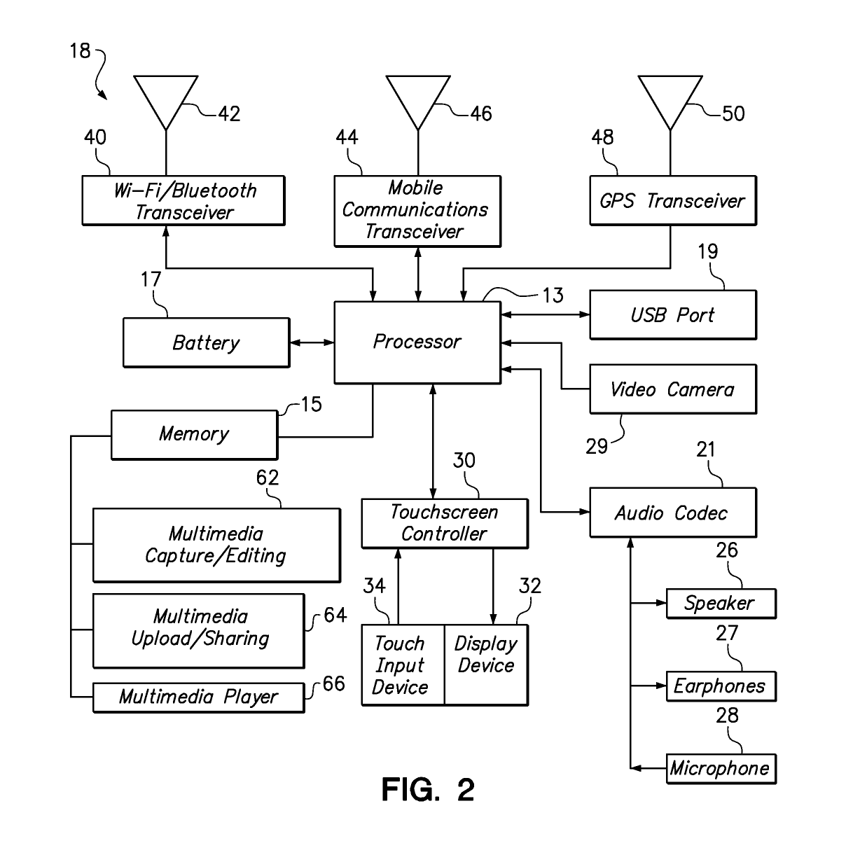

FIG. 2 is a block diagram of the components in one example of a mobile communication device 18, such as a smart phone, capable of implementing embodiments of the present invention. The block diagram may be representative of any one or more mobile communication device 18 or other devices 12, 14, 16, 22, 24 in accordance with various embodiments of the present invention. The communication device 18 may include a processor 13, memory 15, a battery 17, a universal serial bus (USB) port 19, a video camera 29, and an audio codec 21 coupled to a speaker 26, a microphone 28, and an earphone jack 27. The communication device 10 may further include a touchscreen controller 30 which provides a graphical output to the display device 32 and receives an input from a touch input device 34. Collectively, the display device 32 and touch input device 34 may be referred to as a touchscreen.

The communication device 18 may also include a Wi-Fi and/or Bluetooth transceiver 40 and corresponding antenna 42 allowing the device to communicate with a Bluetooth device or a Wi-Fi router, a mobile communication transceiver 44 and corresponding antenna 46 allowing the device to communicate over a mobile/cellular network, and a global positioning system (GPS) transceiver 48 and corresponding antenna 50 allowing the device to obtain signals from a global positioning system or satellites.

The memory 15 may include any number and type of modules for facilitating embodiments of the invention. For example, the memory 15 may include a multimedia capture and editing module 62, a multimedia upload and sharing module 64, and a multimedia player 66. The multimedia capture and editing module 62 may include logic for enabling the device 18 to receive and store video from the video camera 29 and the microphone 28, and/or editing existing audio and video files. The multimedia upload and sharing module 64 enables the device 18 to communicate a multimedia file to the multimedia file server 100. The multimedia player 66 allows the device 18 to receive multimedia files from the multimedia file server 100 and reproduce them on the display device 32 and speaker 26. In particular, the multimedia player 66 allows the device 18 received different portions of the multimedia file in different streams and merge them to provide the intended multimedia reproduction.

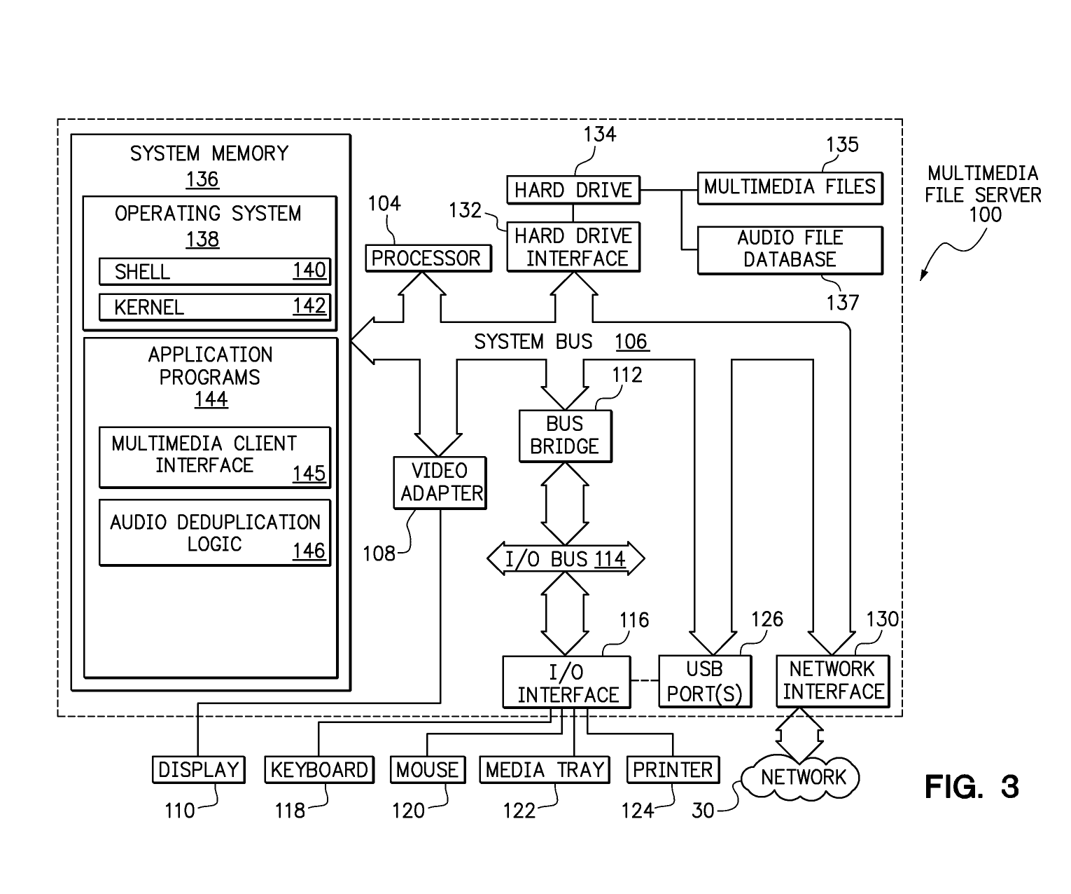

FIG. 3 is a diagram of a multimedia file server 100 that may be utilized consistent with one or more embodiments of the present invention. The multimedia file server 100 includes a processor unit 104 that is coupled to a system bus 106. Processor unit 104 may utilize one or more processors, each of which has one or more processor cores. A video adapter 108, which drives/supports a display 110, is also coupled to the system bus 106. The system bus 106 is coupled via a bus bridge 112 to an input/output (I/O) bus 114, and an I/O interface 116 is coupled to I/O bus 114. The I/O interface 116 affords communication with various I/O devices, including a keyboard 118, a mouse 120, a media tray 122 (which may include storage devices such as CD-ROM drives, multi-media interfaces, etc.), a printer 124, and USB port(s) 126. While the format of the ports connected to the I/O interface 116 may be any format known to those skilled in the art of computer architecture, in a preferred embodiment some or all of these ports are universal serial bus (USB) ports. As depicted, the multimedia file server 100 is able to communicate over a network 30 using a network interface 130.

A hard drive interface 132 is also coupled to system bus 106. The hard drive interface 132 interfaces with a hard drive 134. In a preferred embodiment, the hard drive 134 populates a system memory 136, which is also coupled to the system bus 106. System memory is defined as a lowest level of volatile memory in multimedia file server 100. This volatile memory includes additional higher levels of volatile memory (not shown), including, but not limited to, cache memory, registers and buffers. Data that populates the system memory 136 includes the operating system (OS) 138 and application programs 144 for the multimedia file server 100.

The operating system 138 includes a shell 140, for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 is a text-based, line-oriented user interface, the present invention will equally well support other user interface modes, such as graphical, voice, gestural, etc.

As depicted, the OS 138 also includes a kernel 142, which includes lower levels of functionality for the OS 138, including providing essential services required by other parts of the OS 138 and the application programs 144, including memory management, process and task management, disk management, and mouse and keyboard management. The application programs 144 in the system memory of multimedia file server 100 may include various application programs and modules for implementing the methods described herein, such as a multimedia client interface 145 and audio deduplication logic 146. Furthermore, the hard drive 134, or alternative data storage, may store the multimedia files 135 received from the communication device 18 and store an audio file database 137.

The hardware elements depicted in the multimedia file server 100 are not intended to be exhaustive, but rather are representative components suitable to perform the processes of the present invention. For instance, multimedia file server 100 may include alternate memory storage devices such as magnetic cassettes, digital versatile disks (DVDs), Bernoulli cartridges, and the like. These and other variations are intended to be within the spirit and scope of the present invention.

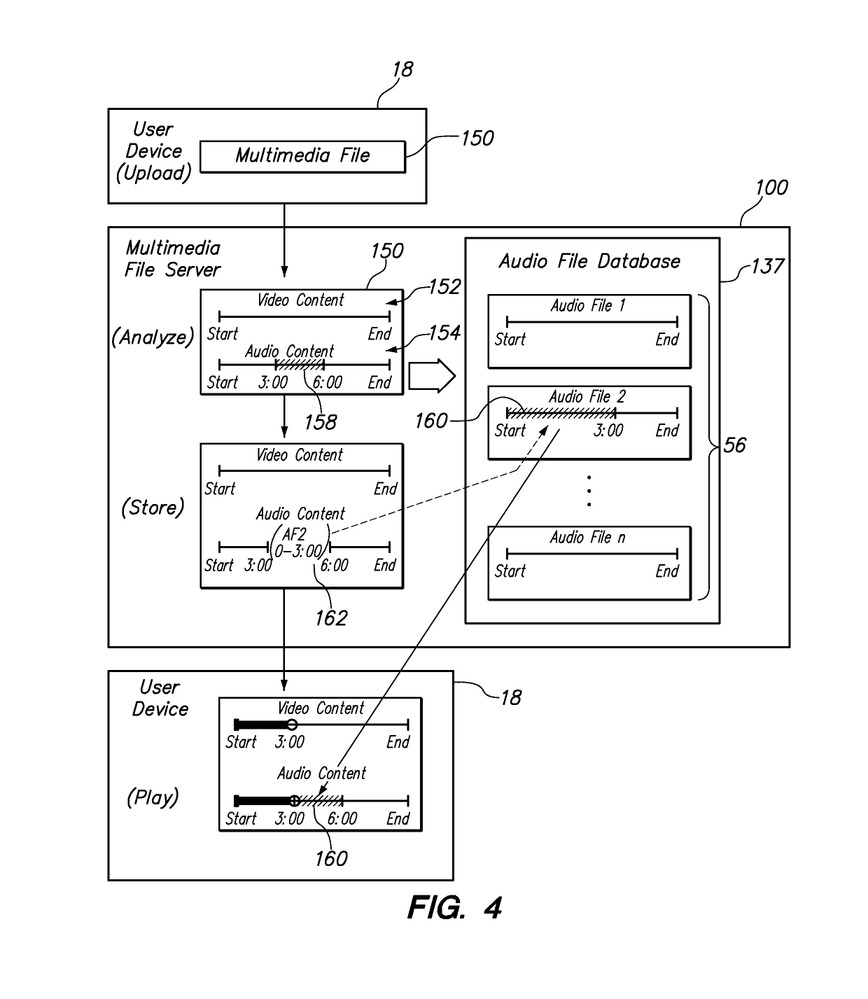

FIG. 4 is a diagram illustrating various aspects of a method in accordance with one embodiment of the present invention. A first user device 18 has a multimedia file 150 that is uploaded to the multimedia file server 100. The multimedia file server 100 then identifies the video content 152 and the audio content 154 of the multimedia file 150, and analyzes the audio content 154 by comparing the audio content 154 with various audio files 156 stored in the audio file database 137. As shown, the audio content 154 has been found to have an identified portion 158 that is the same as a portion 160 of the Audio File 2 in the audio file database 137. Accordingly, the multimedia file is then stored without the identified portion 158, but with a link 162 that points to the portion 160 and specifies that the portion 160 is the first three minutes (0-3:00) of the Audio File 2 (AF2). Furthermore, the link 162 identifies that the portion 160 should be inserted or reproduced in a particular portion (3:00-6:00) of the multimedia file timeline. Accordingly, when a multimedia player on the second user device 18 requests the multimedia file, it receives a first data stream providing the video content and a portion of the audio content (0-3:00 and 6:00-End) and a second data stream providing the portion 160 of Audio File 2. The multimedia player will insert the portion 160 as specified by the link 162.

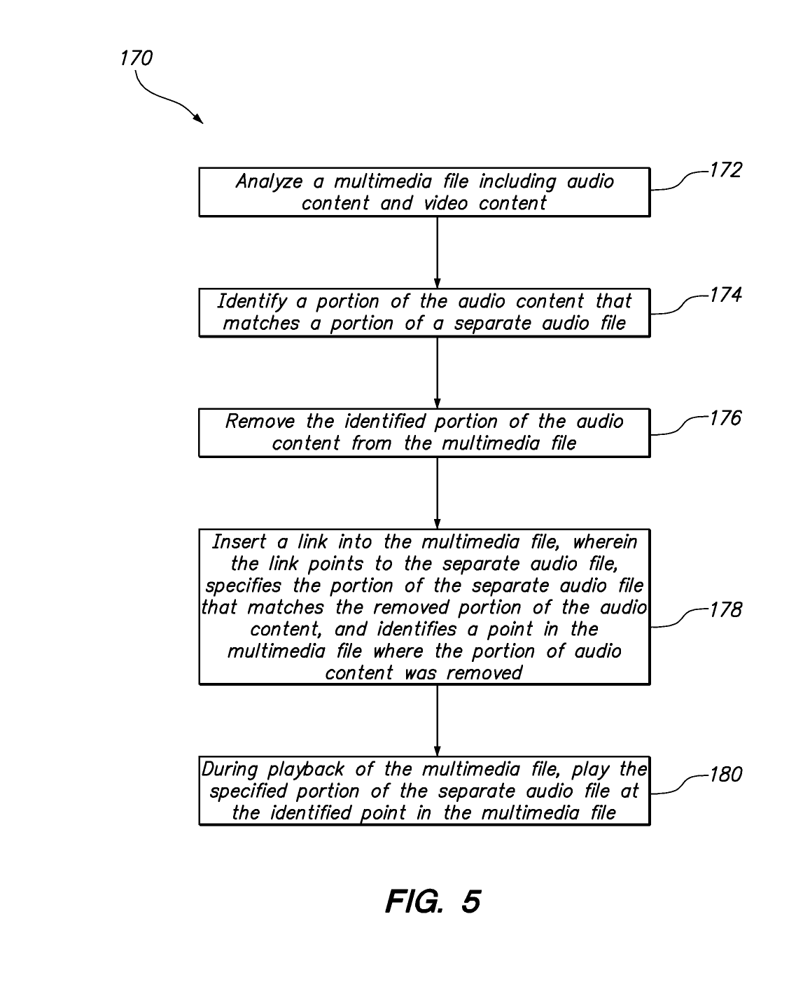

FIG. 5 is a flowchart of a method 170 in accordance with one embodiment of the present invention. The method analyzes a multimedia file including audio content and video content, in step 172, and then identifies a portion of the audio content that matches a portion of a separate audio file, in step 174. In step 176, the identified portion of the audio content is removed from the multimedia file, and then step 178 inserts a link into the multimedia file, wherein the link points to the known audio file, specifies the portion of the separate audio file that matches the removed portion of the audio content, and identifies a point in the multimedia file where the portion of audio content was removed. Step 180 of the method specifies that, during playback of the multimedia file, the specified portion of the separate audio file is played at the identified point in the multimedia file.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
analyzing a multimedia file including audio content and video content;
identifying a portion of the audio content that matches a portion of a separate audio file;
removing the identified portion of the audio content from the multimedia file;
inserting a link into the multimedia file, wherein the link points to the known audio file, specifies the portion of the separate audio file that matches the removed portion of the audio content, and identifies a point in the multimedia file where the portion of audio content was removed; and
during playback of the multimedia file, playing the specified portion of the known audio file at the identified point in the multimedia file.

2. The method of claim 1, further comprising:
storing the multimedia file with the link and without the identified portion of the audio content.

3. The method of claim 1, wherein identifying a portion of the audio content that matches a portion of a separate audio file, includes comparing the audio content of the multimedia file with a database of audio files.

4. The method of claim 1, wherein the identified portion of the audio content is a portion of a song.

5. The method of claim 1, wherein the identified point in the multimedia file includes a start time and an end time.

6. The method of claim 1, further comprising:
analyzing the portion of the audio content to identify an audio effect applied to the portion of the audio content relative to the specified portion of the audio file.

7. The method of claim 1, wherein the known audio file includes higher quality audio than the identified portion of the audio content.

8. The method of claim 1, further comprising:
determining an amount of data included in the identified portion of the audio content, wherein the identified portion of the audio content is removed and the link inserted only in response to the amount of data exceeding a setpoint amount.

9. The method of claim 1, further comprising:
during playback of the multimedia file, providing the multimedia file stored with the link to a multimedia player in a first data stream and providing the specified portion of the separate audio file to the multimedia player in a second data stream.

10. A computer program product for controlling an autonomous vehicle, the computer program product comprising a computer readable storage medium having program instructions embodied therewith, the program instructions executable by a processor to cause the processor to perform a method comprising:
analyzing a multimedia file including audio content and video content;
identifying a portion of the audio content that matches a portion of a separate audio file;
removing the identified portion of the audio content from the multimedia file;
inserting a link into the multimedia file, wherein the link points to the known audio file, specifies the portion of the separate audio file that matches the removed portion of the audio content, and identifies a point in the multimedia file where the portion of audio content was removed; and
during playback of the multimedia file, playing the specified portion of the known audio file at the identified point in the multimedia file.

11. The computer program product of claim 10, the method further comprising:
storing the multimedia file with the link and without the identified portion of the audio content.

12. The computer program product of claim 1, wherein identifying a portion of the audio content that matches a portion of a separate audio file, includes comparing the audio content of the multimedia file with a database of audio files.

13. The computer program product of claim 10, wherein the identified portion of the audio content is a portion of a song.

14. The computer program product of claim 10, wherein the identified point in the multimedia file includes a start time and an end time.

15. The computer program product of claim 10, the method further comprising:
analyzing the portion of the audio content to identify an audio effect applied to the portion of the audio content relative to the specified portion of the audio file.

16. The computer program product of claim 10, wherein the known audio file includes higher quality audio than the identified portion of the audio content.

17. The computer program product of claim 10, the method further comprising:
determining an amount of data included in the identified portion of the audio content, wherein the identified portion of the audio content is removed and the link inserted only in response to the amount of data exceeding a setpoint amount.

18. The computer program product of claim 10, the method further comprising:
during playback of the multimedia file, providing the multimedia file stored with the link to a multimedia player in a first data stream and providing the specified portion of the separate audio file to the multimedia player in a second data stream.
